(19) United States
(12) Patent Application Publication
(10) Pub. No.: US 2013/0138871 A1
(43) Pub. Date: May 30, 2013

(54) Flash Memory Device and Data Access Method for Same

(71) Applicant: SILICON MOTION, INC., Jhubei City (TW)

(72) Inventors: Yi-Sen Chiu, New Taipei City (TW); Hsu-Ping Ou, Zhubei City (TW)

(73) Assignee: SILICON MOTION, INC., Jhubei City (TW)

(21) Appl. No.: 13/685,956

(22) Filed: Nov. 27, 2012

(30) Foreign Application Priority Data
Nov. 30, 2011 (TW) 100143912

(51) Int. Cl. G06F 12/02

(52) U.S. Cl. CPC G06F 12/0246
USPC 711/103

(57) ABSTRACT

The invention provides a flash memory device. In one embodiment, the flash memory device is coupled to a host, and comprises a flash memory, a controller, and a random access memory. The flash memory comprises a plurality of blocks for data storage. The random access memory stores a read count table for recording read counts of the blocks. When the read counts of a plurality of original blocks are greater than a threshold according to the read count table, the controller obtains a plurality of spare blocks from the flash memory as mirror blocks respectively corresponding to the original blocks, and copies a portion of a plurality of data pages of the original blocks to the mirror blocks whenever the original blocks are read until all of the data pages of the original blocks have been copied to the mirror blocks.

### CROSS REFERENCE TO RELATED APPLICATIONS

This Application claims priority of Taiwan Patent Application No. 100143912, filed on Nov. 30, 2011, the entirety of which is incorporated by reference herein.

### BACKGROUND OF THE INVENTION

1. Field of the Invention

The invention relates to flash memories, and more particularly to data access of flash memories.

2. Description of the Related Art

A flash memory is usually installed in an electronic apparatus for data storage. The flash memory comprises a plurality of blocks for data storage. Because the flash memory can maintain data stored therein while power supplied to the flash memory is switched off, and a portable electronic device has a limited power supply, the flash memory is often used in a portable electronic device for data storage.

A controller controls data access of a flash memory. When a host sends a write command to the controller, the controller writes data to the flash memory according to the write command. When the host sends a read command to the controller, the controller reads data from the flash memory according to the read command, and then sends the data back to the host.

When a host reads data from a flash memory, the host often reads data from specific blocks of the flash memory at a high frequency. For example, the host may read a specific block at a frequency of several thousand Hz. An ordinary block, however, can tolerate predetermined times of data reading. When a read count of a block is greater than a threshold (such as 100,000 times), the data read from the block easily develops errors. The controller, however, cannot control the data reading of the host, and can only read data from the blocks of the flash memory according to instructions from the host. Because data read at a high frequency by the host is often system data with high importance, if the system data read out from the flash memory comprises errors, the errors in the system data induces severe errors to the operations of the host. Thus, to avoid errors in the reading of data from a flash memory, a data access method for a flash memory device is therefore required.

### BRIEF SUMMARY OF THE INVENTION

The invention provides a flash memory device. In one embodiment, the flash memory device is coupled to a host, and comprises a flash memory, a controller, and a random access memory. The flash memory comprises a plurality of blocks for data storage. The random access memory stores a read count table for recording read counts of the blocks. When the read counts of a plurality of original blocks are greater than a threshold according to the read count table, the controller obtains a plurality of spare blocks from the flash memory as mirror blocks respectively corresponding to the original blocks, and copies a portion of a plurality of data pages of the original blocks to the mirror blocks whenever the original blocks are read until all of the data pages of the original blocks have been copied to the mirror blocks.

The invention further comprises a data access method for a flash memory device. In one embodiment, the flash memory device is coupled to a host and comprises a flash memory and a random access memory, and the flash memory comprises a plurality of blocks for data storage. First, a read count table for recording read counts of the blocks is stored in the random access memory. When the read counts of a plurality of original blocks are greater than a threshold according to the read count table, a plurality of spare blocks are obtained from the flash memory as mirror blocks respectively corresponding to the original blocks. Whenever the original blocks are read, a portion of a plurality of data pages of the original blocks are copied to the mirror blocks, until all of the data pages of the original blocks have been copied to the mirror blocks

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a flash memory device according to the invention;

FIG. 2 is a schematic diagram of a read count table according to the invention;

FIG. 3 is a flowchart of a method for processing a read command sent from a host according to the invention;

FIG. 4 is a schematic diagram of data copied from the original block to a mirror block according to the invention;

FIG. 5 is a flowchart of a method for rebuilding a read count table after power to the host is switched on according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

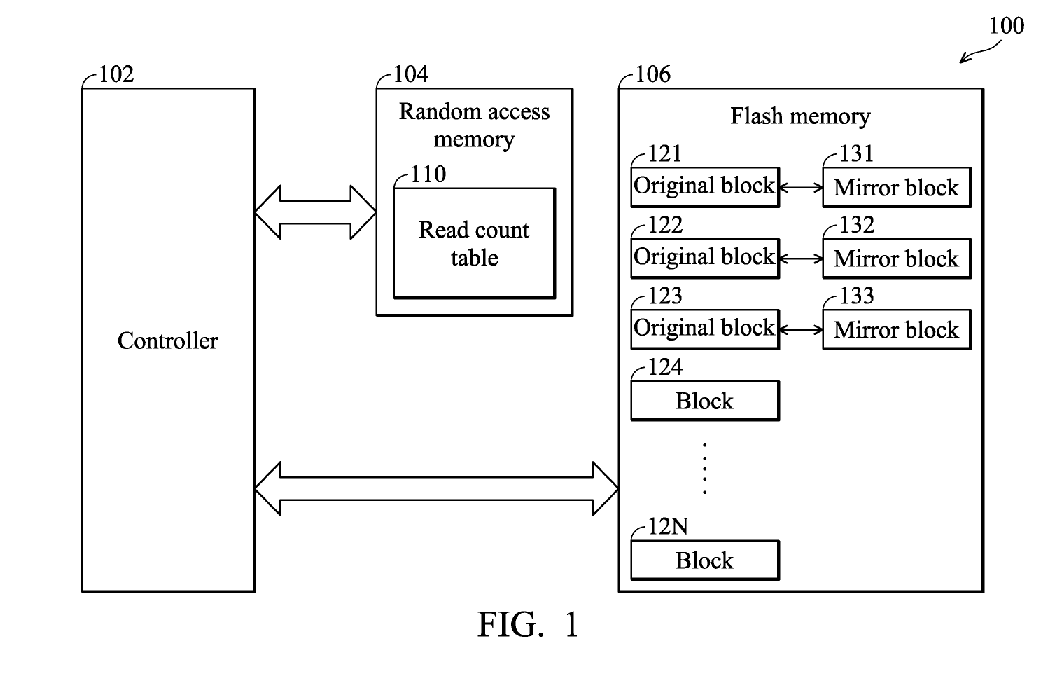

Referring to FIG. 1, a block diagram of a flash memory device 100 according to the invention is shown. The flash memory device 100 is coupled to a host, and stores data for the host. In one embodiment, the flash memory device 100 comprises a controller 102, a random access memory 104, and a flash memory 106. The random access memory 104 may be comprised by the controller 102. The controller 102 accesses data from the flash memory 106 according to commands sent by the host. When the host sends a write command to the controller 102, the controller 102 writes data to the flash memory 106 according to the write command. When the host sends a read command to the controller 102, the controller 102 reads data from the flash memory 106 according to the read command, and then sends data back to the host.

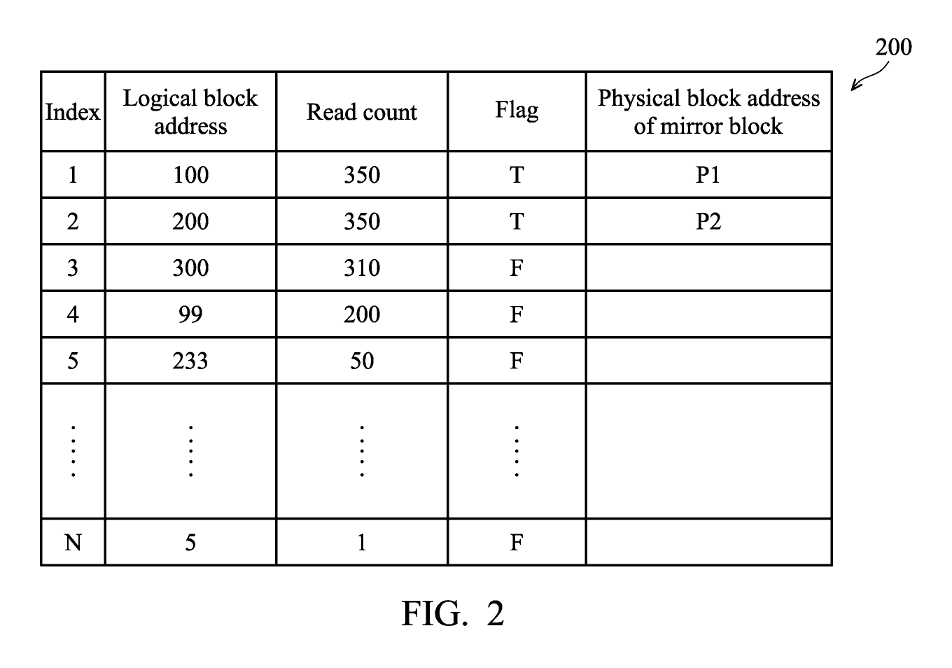

The flash memory 106 comprises a plurality of blocks 121˜12N for data storage. The random access memory 104 stores a read count table 110. The frequency at which blocks of the flash memory 106 are read by the host is referred to as read counts corresponding to the blocks and are recorded in the read count table 110. Referring to FIG. 2, a schematic diagram of a read count table 200 according to the invention is shown. In one embodiment, logical block addresses and read counts of the blocks of the flash memory 106 are recorded in the read count table 200. For example, the read count of the block with a logical block address 100 is 350, and the read count of the block with a logical block address 300 is 310.

The controller 102 updates the read count table 110 stored in the random access memory 104 with time. For example, when the controller 102 receives a read command from the host, the controller 102 determines a target block to be read from the blocks of the flash memory 106 according to a read address of the read command. The controller 102 then increases the read count of the target block in the read count table 110 by one. The read count table 110 therefore always faithfully indicates the read frequency of the blocks of the flash memory 106.

When the controller 102 determines that a read count of an original block is greater than a threshold, the host therefore reads the original block at a high frequency, and the data stored in the original block may be damaged. To prevent data stored in the original block from being damaged, the controller 102 obtains a spare block from the flash memory 106 as a mirror block corresponding to the original block. The controller 102 then gradually copies the data stored in the original block to the mirror block. When all of the data stored in the original block have been copied to the mirror block, if the host wants to read data from the original block again, the controller 102 reads data from the mirror block in place of the original block. The read count of the original block is therefore not increased, and the data stored in the original block is prevented from being damaged.

For example, the controller 102 shown in FIG. 1 determines that the read counts of the blocks 121, 122, and 123 are greater than a threshold value, and the controller 102 copies data from the original blocks 121, 122, and 123 to the mirror blocks 131, 132, and 133. When the host wants to read data from the original blocks 121, 122, or 123 again, the controller 102 reads data copied from the mirror blocks 131, 132, or 133 instead of reading data from the original blocks 121, 122, or 123. Thus, even if the host wants to read the original blocks 121, 122, and 123 at a high frequency, the controller 102 physically reads data from the mirror blocks 131, 132, and 133, the read counts of the original blocks 121, 122, and 123 are therefore prevented from being increased, and data stored in the original blocks 121, 122, and 123 are prevented from being damaged due to reading at high frequency.

In one embodiment, physical block addresses of mirror blocks corresponding to original blocks are further recorded in the read count table 110. For example, in addition to read counts and logical block addresses of blocks, the read count table 200 further stores physical addresses of mirror blocks and a flag. The flag indicates whether a mirror block corresponding to an original block exists in the flash memory 106. When the flag corresponding to a target original block is set to be true, the controller 102 reads data from the mirror block instead of the target original block. For example, assume that a threshold for a read count is 300. Because the read counts of the blocks with logical addresses 100 and 200 are both 350, which is greater than the threshold 300, mirror blocks corresponding to the blocks with logical addresses 100 and 300 are built, and flags corresponding to the blocks with logical addresses 100 and 300 are set to be true.

Ordinarily, an original block comprises a plurality of pages. It requires a long time period to read all data pages from the original block and then write the data pages to the mirror blocks. According to the specification of data transmission between the controller 102 and the host, the controller 102 can only process a write command sent by the host within a limited time period. To prevent the time period in which the controller 102 processes a write command from becoming longer than the limit threshold, whenever the controller 102 receives a read command for reading a target original block from the host, the controller 102 reads a single data page from the target original block, and writes the single data page to a target mirror block corresponding to the target original block, thereby gradually implementing data copied from the target original block to the target mirror block.

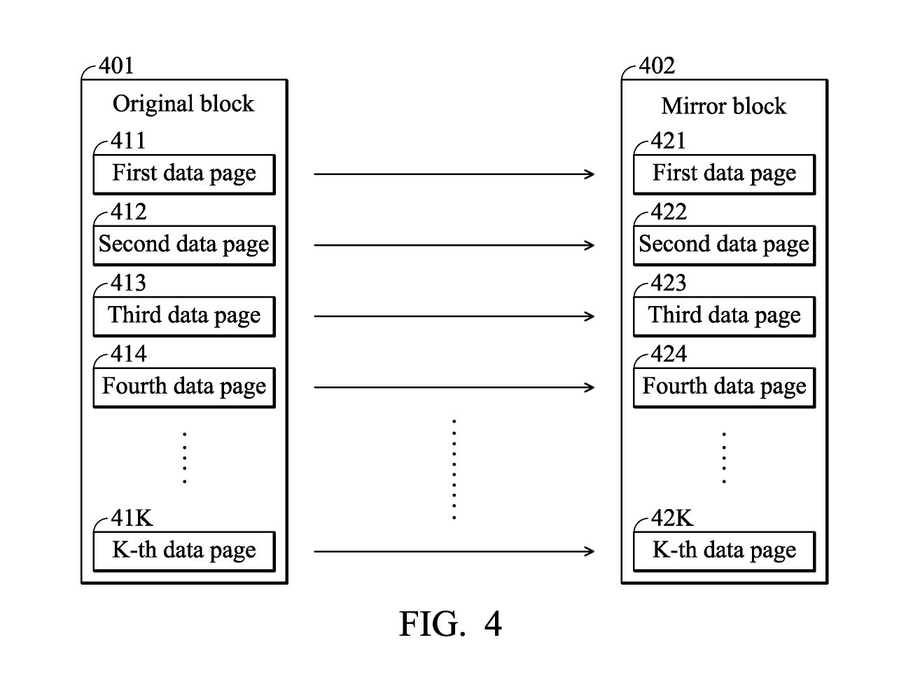

Referring to FIG. 4, a schematic diagram of data copied from an original block 401 to a mirror block 402 according to the invention is shown. The original block 401 comprises K data pages 411˜41K. The controller 102 obtains a spare block 402 from the flash memory 106 as the mirror block corresponding to the original block 401. When the controller 102 receives a first read command for reading the original block 401, the controller 102 merely reads a first data page 411 from the original block 401, and then writes the first data page to a page 421 of the mirror block 402. When the controller 102 receives a second read command for reading the original block 401, the controller 102 reads a second data page 412 from the original block 401, and then writes the second data page to a page 422 of the mirror block 402. Finally, when the controller 102 receives a K-th read command for reading the original block 401, the controller 102 reads a K-th data page 41K from the original block 401, and then writes the K-th data page to a page 42K of the mirror block 402. The controller 102 therefore completes data copy from the original block 401 to the mirror block 402. The controller 102 then sets the flag corresponding to the original block 401 in the read count table 110 to be “true” to indicate that data copy of the original block 401 is completed.

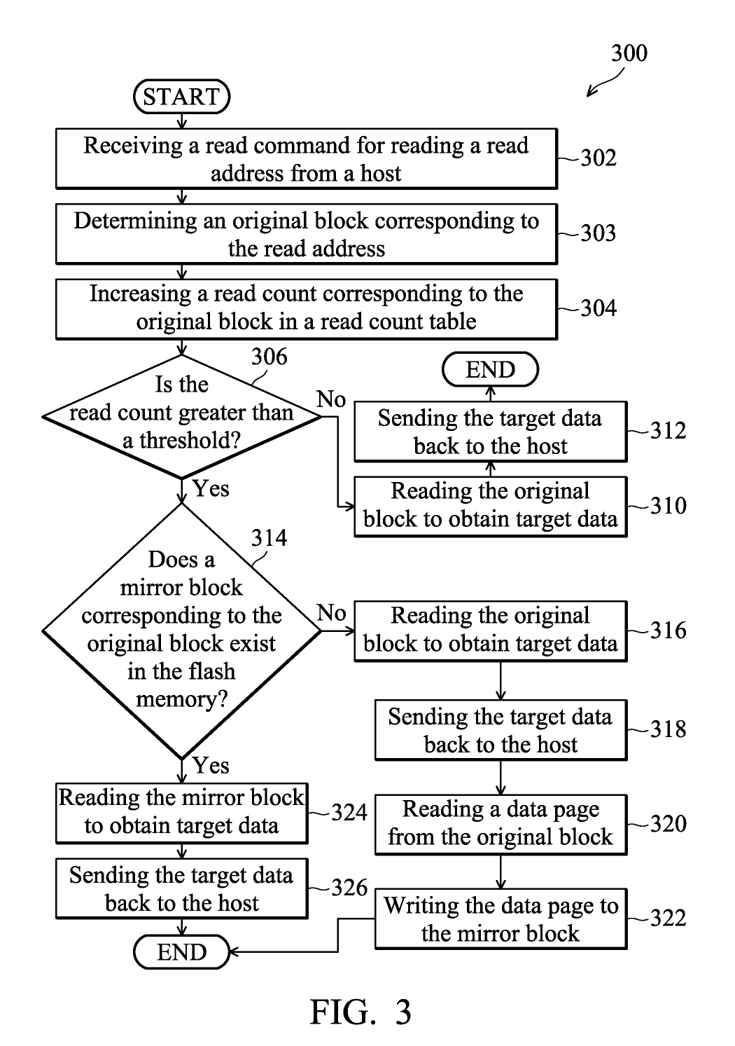

Referring to FIG. 3, a flowchart of a method 300 for processing a read command sent from a host according to the invention is shown. First, the controller 102 receives a read command for reading a read address from a host (step 302). The controller 102 then determines an original block corresponding to the read address (step 303). The controller 102 then increases the read count corresponding to the original block by one in the read count table 110 (step 304). The controller 102 then determines whether the read count of the original block is greater than a threshold (step 306). When the read count of the original block is less than the threshold, the controller 102 reads the original block to obtain target data (step 310), and then sends the target data back to the host to complete execution of the read command (step 312).

When the read count of the original block is greater than the threshold (step 306), the controller 102 determines whether a mirror block corresponding to the original block exists in the flash memory 106 (step 314). In one embodiment, the controller 102 checks the flag corresponding to the original block in the read count table 110 to determine whether the mirror block corresponding to the original block exists in the flash memory 106. When the mirror block corresponding to the original block exists in the flash memory 106, the controller 102 reads the mirror block to obtain target data (step 324), and sends the target data back to the host to complete execution of the read command (step 326).

When the read count of the original block is greater than the threshold (step 306), and a mirror block corresponding to the original block does not exist in the flash memory 106 (step 314), data copy from the original block to the mirror block has not been completed. Thus, the controller 102 reads the original block to obtain target data (step 316), and sends the target data back to the host to complete execution of the read command (step 318). In addition, because data copy from the original block to the mirror block has not been completed, the controller 102 reads a data page from the original block (step 320), and writes the data page to the mirror block during the remaining time for processing the read command (step 322). If the data page is a last page of the original block, the controller 102 sets the value of the flag corresponding to the original block in the read count table 110 to be “true”, to indicate that the mirror block corresponding to the original block has been built.

After the mirror block is built, the data stored in the mirror block may also be damaged due to reading at a high frequency. When the controller 102 reads the data copy from the mirror block and finds that the data copy comprises errors which cannot be corrected by an error correction process, the controller 102 rebuilds a second mirror block corresponding to the original block. First, the controller 102 obtains a spare block from the flash memory 106 as the second mirror block. Whenever the host sends a read command for reading the original block to the controller 102, the controller 102 copies a data page from the original block to the second mirror block, until all data pages of the original block have been copied to the second mirror block. After the second mirror block is built, the controller 102 can read data from the second mirror block in place of the original block to execute a read command for reading the original block.

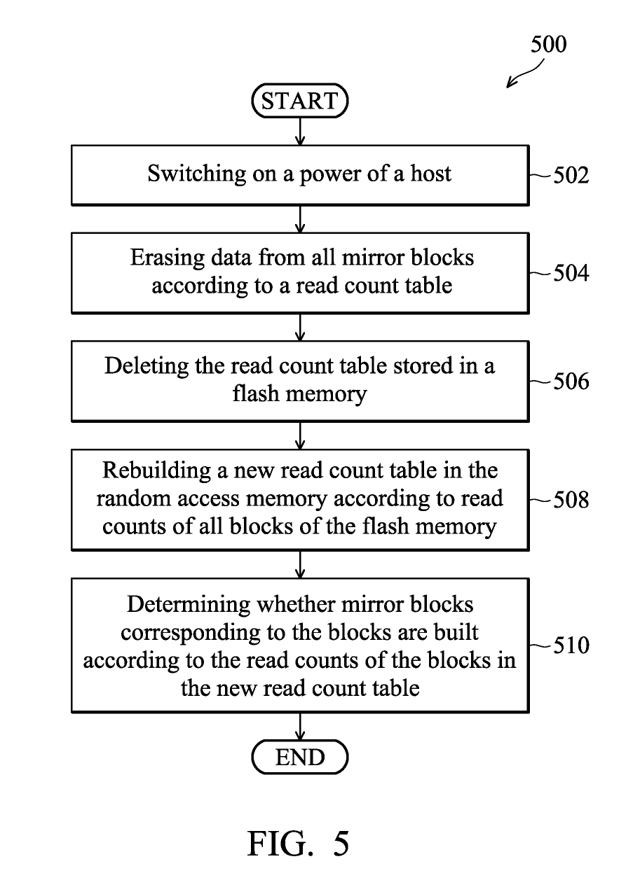

When power to the host is switched off, the flash memory device 100 cannot obtain power from the host, and the random access memory 104 cannot keep the read count table 110 stored therein. The controller 102 therefore writes the read count table 110 from the random access memory 104 to the flash memory 106 before power to the host is switched off. Referring to FIG. 5, a flowchart of a method 500 for rebuilding a read count table 110 after host power is switched on according to the invention is shown. First, power to the host is switched on (step 502). The controller 102 then reads a read count table stored in the flash memory, and erases data from all previous mirror blocks according to the read count table to convert the previous mirror blocks to spare blocks (step 504). The controller 102 then deletes the read count table stored in the flash memory 106 (step 506). The controller 102 then rebuilds a new read count table in the random access memory 104 according to read counts of all blocks of the flash memory 106 (step 508). Finally, the controller 102 determines whether mirror blocks corresponding to the blocks are built according to the read counts of the blocks in the new read count table (step 510).

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A flash memory device, coupled to a host, comprising:
a flash memory, comprising a plurality of blocks for data storage;
a random access memory, storing a read count table for recording read counts of the blocks; and
a controller, when the read counts of a plurality of original blocks are greater than a threshold according to the read count table, obtaining a plurality of spare blocks from the flash memory as mirror blocks respectively corresponding to the original blocks, and copying a portion of a plurality of data pages of the original blocks to the mirror blocks whenever the original blocks are read until all of the data pages of the original blocks have been copied to the mirror blocks.

2. The flash memory device as claimed in claim 1, wherein when the controller receives a read command from the host, the controller determines a target original block corresponding to a read address of the read command, and increases the read count corresponding to the target original block by 1 in the read count table.

3. The flash memory device as claimed in claim 2, wherein when the controller receives the read command from the host, if a target mirror block corresponding to the target original block does not exist, the controller reads the target original block to obtain target data, and sends the target data back to the host.

4. The flash memory device as claimed in claim 2, wherein when the controller receives the read command from the host, if a target mirror block corresponding to the target original block exists, the controller reads the target mirror block to obtain target data, and sends the target data back to the host.

5. The flash memory device as claimed in claim 1, wherein logical block block addresses of the mirror blocks corresponding to the original blocks are recorded in the read count table.

6. The flash memory device as claimed in claim 5, wherein a flag indicating whether the mirror blocks corresponding to the original blocks exist is further recorded in the read count table.

7. The flash memory device as claimed in claim 4, wherein when the target data read from the target mirror block comprises errors which cannot be corrected by an error correction process, the controller erases data from the target mirror block, obtains a second spare block from the flash memory as a second mirror block corresponding to the target original block, and copies a portion of the data pages of the target original block to the second mirror block whenever the target original block is read until all of the data pages of the target original block have been copied to the second mirror block.

8. The flash memory device as claimed in claim 1, wherein the controller writes the read count table to the flash memory before the power of the host is switched off, and when the power of the host is switched on, the controller erases data from all of the mirror blocks according to the read count table, deletes the read count table stored in the flash memory, and rebuilds a new read count table in the random access memory according to the read counts of the blocks.

9. A data access method for a flash memory device, wherein the flash memory device is coupled to a host and comprises a flash memory and a random access memory, and the flash memory comprises a plurality of blocks for data storage, the data access method comprising:
storing a read count table for recording read counts of the blocks in the random access memory;
when the read counts of a plurality of original blocks are greater than a threshold according to the read count table, obtaining a plurality of spare blocks from the flash memory as mirror blocks respectively corresponding to the original blocks; and
whenever the original blocks are read, copying a portion of a plurality of data pages of the original blocks to the mirror blocks, until all of the data pages of the original blocks have been copied to the mirror blocks.

10. The data access method as claimed in claim 9, wherein the data access method further comprises:
when the flash memory device receives a read command from the host, determining a target original block corresponding to a read address of the read command, and increasing the read count corresponding to the target original block by 1 in the read count table.

11. The data access method as claimed in claim 10, wherein the data access method further comprises:
when the flash memory device receives the read command from the host, if a target mirror block corresponding to the target original block does not exist, reading the target original block to obtain target data, and sending the target data back to the host.

12. The data access method as claimed in claim 10, wherein the data access method further comprises:
when the flash memory device receives the read command from the host, if a target mirror block corresponding to the target original block exists, reading the target mirror block to obtain target data, and sending the target data back to the host.

13. The data access method as claimed in claim 9, wherein logical block addresses of the original blocks, the read counts of the original blocks, and physical block addresses of the mirror blocks corresponding to the original blocks are recorded in the read count table.

14. The data access method as claimed in claim 13, wherein a flag indicating whether the mirror blocks corresponding to the original blocks exist is further recorded in the read count table.

15. The data access method as claimed in claim 12, wherein the data access method further comprises:
when the target data read from the target mirror block comprises errors which cannot be corrected by an error correction process, erasing data from the target mirror block;
obtaining a second spare block from the flash memory as a second mirror block corresponding to the target original block; and
copying a portion of the data pages of the target original block to the second mirror block whenever the target original block is read until all of the data pages of the target original block have been copied to the second mirror block.

16. The data access method as claimed in claim 9, wherein the data access method further comprises:
writing the read count table to the flash memory before the power of the host is switched off; and
when the power of the host is switched on, erasing data from all of the mirror blocks according to the read count table, deleting the read count table stored in the flash memory, and rebuilding a new read count table in the random access memory according to the read counts of the blocks.
